(19) United States
(12) Patent Application Publication
(10) Pub. No.: US 2026/0205852 A1
(43) Pub. Date: Jul. 16, 2026

(54) METHOD AND DEVICE FOR CLI MEASUREMENT IN WIRELESS COMMUNICATION SYSTEM

(71) Applicant: Samsung Electronics Co., Ltd., Suwon-si, Gyeonggi-do (KR)

(72) Inventors: Kwonjong LEE, Suwon-si (KR); Sangwon JUNG, Suwon-si (KR); Jungsoo JUNG, Suwon-si (KR)

(21) Appl. No.: 19/136,692

(22) PCT Filed: Jan. 10, 2024
(86) PCT No.: PCT/KR2024/095017

§ 371 Date: Jun. 6, 2025

(30) Foreign Application Priority Data
Feb. 9, 2023 (KR) 10-2023-0017203

(51) Int. Cl. H04W 24/10

(52) U.S. Cl. CPC H04W 24/10

(57) ABSTRACT

The disclosure relates to a 5G or 6G communication system for supporting data transmission rates higher than that of a 4G communication system such as LTE. The disclosure relates to a configuration process for CLI measurement, and a CLI measurement method and device.

### TECHNICAL FIELD

The disclosure relates to a wireless communication system (or a mobile communication system). More specifically, the disclosure relates to a method and a device for measuring cross-link interference (CLI) in a wireless communication system (or a mobile communication system) and, more particularly, to improving the accuracy of CLI measurement results.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobiles devices are expected to evolve into various formfactors such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (i.e., 1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mm Wave bands introduced in 5G, a technology capable of securing the signal transmission distance, that is, coverage, will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

Meanwhile, there have been increasing requests for improving CLI measurement processes in line with recent development of communication systems.

### DISCLOSURE OF INVENTION

### Technical Problem

The disclosure proposes a scheme for improving CLI measurement processes. More specifically, the disclosure proposes a scheme for preventing CLI measurement results from being degraded by uplink signals from a UE when measuring CLI between base stations of different cells. In addition, the disclosure proposes a scheme for preventing CLI measurement results from being degraded by downlink signals from a base station when measuring CLI between UEs in the same cell.

The technical subjects pursued in the disclosure may not be limited to the above-mentioned technical subjects, and other technical subjects which are not mentioned herein may be clearly understood from the following description by those skilled in the art to which the disclosure pertains.

### Solution to Problem

A method of a first terminal according to an embodiment proposed in the disclosure includes: receiving configuration information related to measurement regarding a cross-link interference (CLI)-reference signal (RS) from a base station; receiving a CLI-RS from a second terminal, based on the configuration information; and transmitting a CLI measurement result regarding the received CLI-RS to the base station, wherein, in one or more downlink symbols corresponding to a time interval in which the CLI-RS is received from the second terminal, no downlink signal is received from the base station, based on the configuration information.

A method of a first base station according to an embodiment proposed in the disclosure includes: transmitting configuration information related to measurement regarding a (cross-link interference (CLI)-reference signal (RS) to a second base station; transmitting uplink scheduling information based on the configuration information to a terminal; receiving a CLI-RS from the second base station, based on the configuration information; and performing CLI measurement regarding the received CLI-RS, wherein in one or more uplink symbols corresponding to a time interval in which the CLI-RS is received from the second base station, no uplink signal is received from the terminal, based on the configuration information.

A first terminal according to an embodiment proposed in the disclosure includes a transceiver and a controller connected to the transceiver, wherein the controller is configured to receive configuration information related to measurement regarding a cross-link interference (CLI)-reference signal (RS) from a base station, receive a CLI-RS from a second terminal, based on the configuration information, and transmit a CLI measurement result regarding the received CLI-RS to the base station, and wherein, in one or more downlink symbols corresponding to a time interval in which the CLI-RS is received from the second terminal, no downlink signal is received from the base station, based on the configuration information. A first base station according to an embodiment proposed in the disclosure includes a transceiver and a controller connected to the transceiver, wherein the controller is configured to transmit configuration information related to measurement regarding a (cross-link interference (CLI)-reference signal (RS) to a second base station, transmit uplink scheduling information based on the configuration information to a terminal, receive a CLI-RS from the second base station, based on the configuration information, and perform CLI measurement regarding the received CLI-RS, and wherein in one or more uplink symbols corresponding to a time interval in which the CLI-RS is received from the second base station, no uplink signal is received from the terminal, based on the configuration information.

### Advantageous Effects of Invention

According to various embodiments proposed in the disclosure, the influence of uplink signals during inter-base station CLI measurement may be removed, thereby improving the accuracy and efficiency of the result of CLI measurement by base stations. In addition, the influence of downlink signals during inter-UE CLI measurement may be removed, thereby improving the accuracy and efficiency of the result of CLI measurement by UEs.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 is a diagram illustrating CLI related to an embodiment of the disclosure.

FIG. 2 is a diagram illustrating a CLI measurement process related to an embodiment of the disclosure.

FIG. 3 is a diagram illustrating a CLI measurement process related to an embodiment of the disclosure. FIG. 4 is a diagram illustrating a CLI measurement process related to an embodiment of the disclosure.

FIG. 5 is a diagram illustrating a CLI measurement process related to an embodiment of the disclosure.

FIG. 6 is a diagram illustrating a CLI measurement situation according to an embodiment of the disclosure.

FIG. 7 is a diagram illustrating a CLI measurement method by a base station according to an embodiment of the disclosure.

FIG. 8 is a flowchart illustrating a CLI measurement-related configuration process according to one embodiment of the disclosure.

FIG. 9 is a flowchart illustrating a CLI measurement-related configuration process according to one embodiment of the disclosure.

FIG. 10 is a flowchart illustrating a CLI measurement process according to one embodiment of the disclosure.

FIG. 11 is a flowchart illustrating a CLI measurement process according to one embodiment of the disclosure.

FIG. 12 is a diagram illustrating a CLI measurement method according to one embodiment of the disclosure.

FIG. 13 is a flowchart illustrating a CLI measurement-related configuration process according to one embodiment of the disclosure.

FIG. 14 is a flowchart illustrating a CLI measurement-related configuration process according to one embodiment of the disclosure.

FIG. 15 is a flowchart illustrating a CLI measurement process according to one embodiment of the disclosure.

FIG. 16 is a flowchart illustrating a CLI measurement process according to one embodiment of the disclosure.

FIG. 17 is a diagram illustrating a CLI-reference signal (CLI-RS) symbol structure according to an embodiment of the disclosure.

FIG. 18 is a drawing illustrating a CLI measurement situation according to one embodiment of the disclosure.

FIG. 19 is a diagram illustrating a CLI measurement method by a UE according to an embodiment of the disclosure.

FIG. 20 is a flowchart illustrating a CLI measurement-related configuration process and a measurement process according to an embodiment of the disclosure.

FIG. 21 is a drawing illustrating a CLI measurement method according to one embodiment of the disclosure.

FIG. 22 is a flowchart illustrating a CLI measurement-related configuration process and a measurement process according to an embodiment of the disclosure.

FIG. 23 is a diagram illustrating a CLI-RS symbol structure according to an embodiment of the disclosure.

FIG. 24 is a diagram illustrating a radio resource structure related to a CLI-RS according to an embodiment of the disclosure.

FIG. 25 is a diagram illustrating a CLI measurement-related configuration process and a measurement process according to an embodiment of the disclosure.

FIG. 26 is a diagram illustrating a CLI measurement-related configuration process and a measurement process according to an embodiment of the disclosure.

FIG. 27 illustrates a structure of a UE according to an embodiment of the disclosure.

FIG. 28 illustrates a structure of a base station according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. In addition, a detailed description of known functions or configurations that may make the subject matter of the disclosure unclear will be omitted.

In describing embodiments set forth herein, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

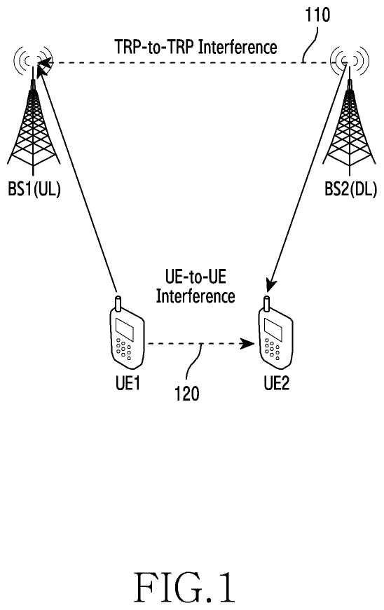

FIG. 1 is a diagram illustrating CLI related to an embodiment of the disclosure.

Prior to describing CLI measurements, a full-duplex communication system will be described first. An in-band full-duplex communication system (hereinafter, referred to as a full-duplex communication system or a full-duplex system) refers to a system in which uplink signals and downlink signals can be transmitted simultaneously within the same band/the same time resource, unlike a time division duplexing (TDD) or a frequency division duplexing (FDD) system. That is, in a full-duplex system, uplink signals and downlink signals are transmitted/received while coexisting at the same timing within the same cell, and this interferes with the transmitting entity and the receiving entity.

As such, in a full-duplex system, only one uplink or downlink signal may be transmitted/received at the same timing as needed, but uplink and downlink signals may also be transmitted/received simultaneously. In addition, interference resulting from signal transmission/reception in a full-duplex system may include not only interference resulting from signals per se transmitted in bands, but also leakage resulting from signals. In addition, full-duplex operations may be implemented with regard to only a part of the entire system band, or may be implemented across the entire band.

Simultaneous transmission in a full-duplex system will be hereinafter described typically in consideration of a transmitter and a receiver belonging to one node (or entity), but also includes full-duplex operation between other nodes that may share information necessary for full-duplex operations by sharing information with each other, even if the transmitter and the receiver belong to different nodes.

Types of interference added by full-duplex systems described above are classified into two types: self-interference and cross-link interference (CLI).

Firstly, the self-interference refers to interference that is received together when one node (for example, node A) receives a signal from another node (for example, node B). As used herein, nodes A and B may include various entities such as a base station, a UE, and an integrated access and backhaul (IAB). In addition, nodes or entities, even if physically separated from each other, may be recognized as one node as long as they are connected to each other in a wired or wireless manner and can share information with each other. Therefore, the self-interference also includes interference that occurs between two different nodes that can share information with each other. In addition, the self-interference may include not only signals received in the same band but also signals received in different bands. In addition, the self-interference may include out-of-band radiation caused by signals transmitted in different bands. In the case of the self-interference, transmission and reception occur at shorter distances than desired signals, thereby significantly reducing the signal to interference and noise ratio (SINR) of the desired signals. Therefore, the performance of a full-duplex system is greatly affected by the self-interference cancellation performance.

Next, the cross-link interference includes interference occurring when a base station that receives uplink signals from a UE receives downlink signals transmitted by another base station in the same band, and interference occurring when a UE that receives downlink signals receive uplink signals transmitted by another UE. In the case of cross-link interference occurring when a base station that receives uplink signals receives downlink signals from another base station (hereinafter, referred to as cross-link interference between base stations), the distance from the interference transmitter to the interference receiver is larger than the distance between the UE that receives desired signals from a base station and the receiver of the base station. However, the transmission power of the base station is generally 10-20 dB or more stronger than the transmission power of the UE, and the reception SINR performance of uplink signals that the base station receive from the UE may thus be greatly affected. In addition, in the case of cross-link interference occurring when a UE that receives downlink signals receives uplink signals from another UE in the same band (hereinafter, referred to as cross-link interference between UEs), the reception SINR performance of downlink signals that a UE receives from a base station may be lowered if the distance from the interference transmitter to the UE is smaller than the distance to the UE that receives downlink signals from the base station in a meaningful manner. The description that the distance from the interference transmitter is smaller in a meaningful manner means that the reception power of interference signals received from the interference transmitter UE (that is, the UE that transmits uplink signals) is stronger than or similar to the reception power of downlink signals received by the interference receiver UE from the base station to such an extent that the SINR performance of downlink signals received by the UE can be lowered.

Meanwhile, types of full-duplex systems in a cellular-based communication systems may include a type in which the self-interference cancellation (SIC) function for supporting full-duplex operations is supported only by base stations, and a type in which the function is supported by both base stations and UEs. In order to cancel self-interference, antenna-separated SIC, radio frequency (RF) circuit-based SIC, digital SIC, or the like needs to be implemented. Base stations have an advantage over UEs in terms of the form factor and circuit structure for such implementation, and the type in which the SIC function is supported only by UEs is accordingly not considered.

In the following disclosure, the type in which base stations support SIC in a full-duplex system is considered, but the following description may be equally or similarly applied also to the case in which both UEs and base stations support the SIC function. Therefore, the term “UE” or “base station” in the following description may not only refer to one UE or base station per se, but also be understood as encompassing other devices (or nodes/entities) having transmission/reception functions.

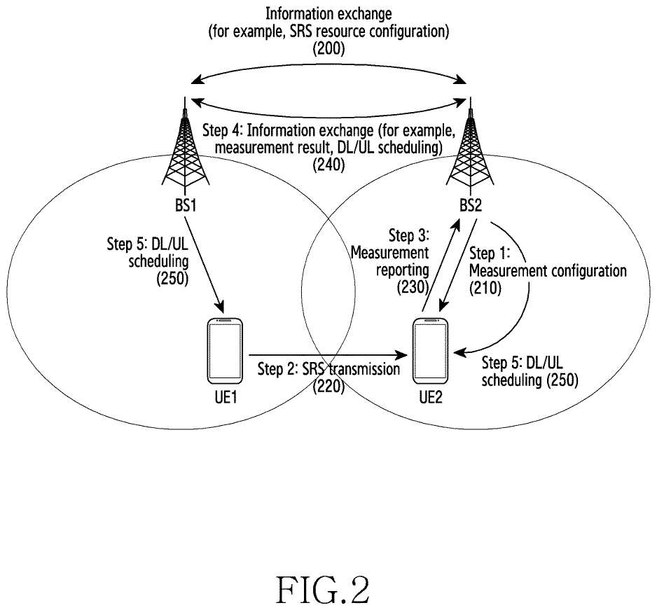

FIG. 2 is a diagram illustrating a CLI measurement process related to an embodiment of the disclosure. Hereinafter, various embodiments for measuring cross-link interference (or CLI) in a full-duplex system are proposed. Prior to describing specific embodiments, a CLI measurement process according to the prior art will be described with reference to FIG. 2.

The conventional CLI measurement process is intended for measurements in a dynamic TDD (D-TDD) system in which the ratio between uplink and downlink frames can be dynamically adjusted, instead of the above-described in-band full-duplex system. Due to insufficient technological development regarding base stations that support the SIC function, which is an essential requirement for a full-duplex system in conventional wireless communication systems such as 5G or wireless fidelity (Wi-Fi), there has been no specific discussion on the SIC function regarding a full-duplex system or the CLI measurement process.

Meanwhile, as described above, the CLI measurement process for controlling CLI in a D-TDD system has only considered a UE-UE CLI measurement method between different cells and, to be specific, may be performed according to a series of procedures described with reference to FIG. 2.

In step 0 in FIG. 2, for the sake of UE-to-UE CLI measurement between different cells, base stations that provide respective cells may share information regarding a radio resource or a reference signal (RS) resource to be used for CLI measurements in advance (200). Such an RS resource may include a sounding reference signal (SRS), but is not limited to the SRS.

In step 1 in FIG. 2, BS2 which is a serving base station of UE2 (a UE that measures CLI) transmits configuration information for CLI measurement to UE2 (210). In step 2, UE1 (a UE that generates CLI) transmits a CLI-reference signal (CLI-RS) or an SRS to UE2 (a UE that measures CLI) for the sake of CLI measurement (220).

UE2 performs CLI measurement with regard to the CLI-RS or SRS received from UE1 and reports the measurement result to BS2 (230). Upon receiving the CLI measurement result, BS2 shares CLI-related information with BS1 with which information regarding the CLI measurement resource has been shared (240), and such CLI-related information may include the CLI measurement result reported by UE2, DL/UL scheduling-related information, and the like. Thereafter, BS1 schedules DL reception and/or UL transmission for UE1, and BS2 schedules DL reception and/or UL transmission for UE2 (250). Such scheduling processes may be performed based on the CLI measurement result previously reported by UE2, and DL reception and UL transmission in different time resources, frequency resources, and spatial resources may be scheduled with regard to UEs deemed to exchange a large CLI influence, for example.

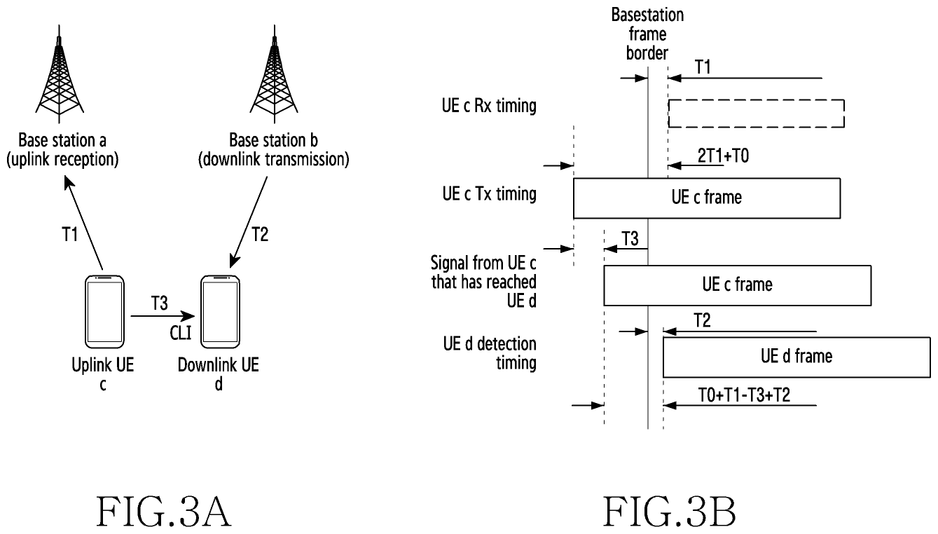

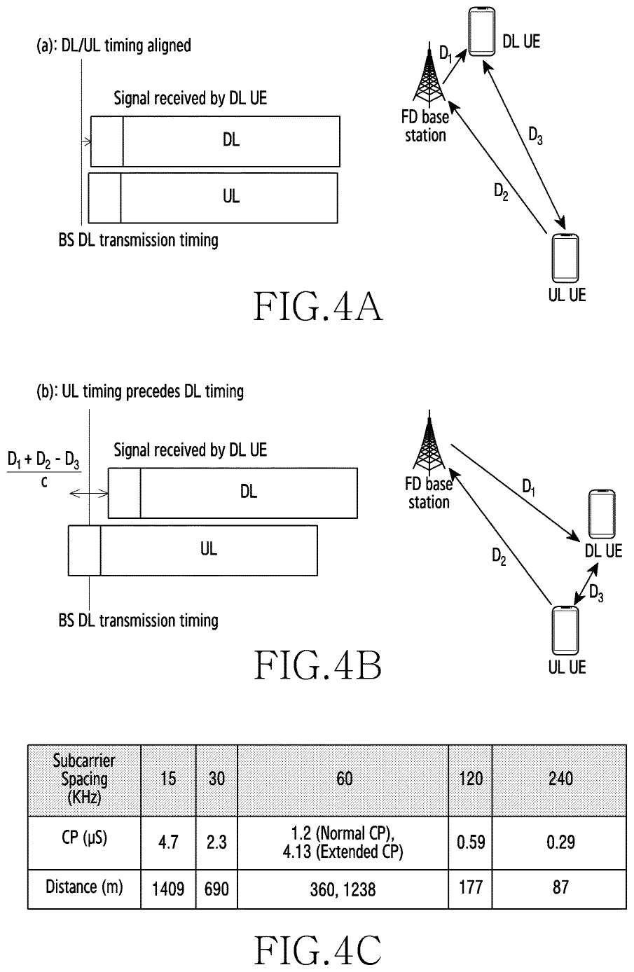

FIG. 3 is a diagram illustrating a CLI measurement process related to an embodiment of the disclosure. As described above, a conventional UE-to-UE CLI measurement process between different cells has mainly been discussed. Such a conventional scheme is insufficient to be applied to a base station-to-base station CLI measurement process between different cells or a UE-to-UE CLI measurement process within the same cell, which has recently been discussed.

Accordingly, the disclosure proposes embodiments for a base station-to-base station CLI measurement process between different cells and a UE-to-UE CLI measurement process within the cell. Particularly, the disclosure proposes a scheme for preventing the CLI measurement efficiency from being degraded by uplink signals from a UE in connection with an embodiment for a base station-to-base station CLI measurement between different cells (or inter-cell BS-BS CLI measurement). In addition, the disclosure proposes a scheme for preventing the CLI measurement efficiency from being degraded by downlink signals from a base station in connection with an embodiment for a UE-to-UE CLI measurement in the same cell (or intra-cell UE-UE CLI measurement).

FIG. 3A illustrates a conventional inter-cell UE-UE CLI measurement situation described above. In FIG. 3A, base station a and base stations b provide different cells, respectively, UE c transmits an uplink signal to base station a in the serving cell provided by base station a, and UE d receives a downlink signal from base station b in the serving cell provided by base station b. In this case, the uplink signal transmitted by UE c generates UE-UE CLI in the downlink signal received by UE d.

Referring to FIG. 3B, in order to determine the transmission timing (Tx timing) of an uplink signal to base station a, UE c may apply a timing advance (TA) to the reception timing (Rx timing) of a signal received from base station a. For example, UE c may determine that the timing obtained by applying a TA corresponding to 2T1+T0 to the Rx timing from the base station is the Tx timing to base station a. T1 is a value based on the propagation delay of a signal transmitted from base station a to UE c, and T0 is an additional offset value determined by the base station for the accuracy of the TA.

UE d receives the uplink signal transmitted by UE c at the Tx timing. UE d receives the signal transmitted by UE c at a timing that precedes by T1+T0−T3 with reference to the base station frame border. T3 is a value based on the propagation delay of the signal transmitted from UE c to UE d. Meanwhile, UE d receives a downlink signal from base station b, and the timing of detection of the downlink signal is shifted from the base station frame border by T2, and T2 is a value based on the propagation delay of the signal transmitted from base station b to UE d. That is, in order for UE d to measure signals from UE c such that the CLI from UE c is measured, UE d needs to start detecting signals from a timing that precedes the existing detection timing by T0+T1−T3+T2.

Conventional operations in the process of determining the signal detection timing for CLI measurement are as follows: UE d configures a detection window in consideration of the T0 value and then expects a cyclic prefix (CP) to be received within a time interval corresponding to T1−T3+T2. That is, UE d would perform CLI detection at a timing advanced by T0 according to the prior art.

Such a conventional scheme may work in the case of a framework for measuring inter-cell UE-to-UE CLI, but cannot work efficiently in a situation in which intra-cell UE-to-UE CLI is measured in a full-duplex system or in a situation in which inter-cell BS-BS CLI is measured. Hereinafter, a scheme in which CLI can be measured efficiently with regard to each of the above-described intra-cell UE-UE CLI or inter-cell BS-BS CLI will be proposed.

FIG. 4 is a diagram illustrating a CLI measurement process related to an embodiment of the disclosure. A situation in which intra-cell CLI is measured will be described in detail with reference to FIG. 4.

FIG. 4A illustrates a situation in which a UE configured to access a base station operating in a full-duplex system (or a full-duplex (FD) base station) and receive downlink signals (hereinafter, referred to as a DL UE) and a UE configured to transmit uplink signals (hereinafter, referred to as a UL UE) are sufficiently spaced apart from each other. FIG. 4B illustrates a situation in which a UE configured to access an FD base station operating in a full-duplex system and receive downlink signals (a DL UE) and a UE configured to transmit uplink signals (a UL UE) are close to each other and are sufficiently spaced apart from the base station.

With regard to both cases in FIG. 4A and FIG. 4B, the uplink signal received by the DL UE from the UL UE is received at a timing that precedes that of the downlink signal received from the base station by (D1+D2−D3)/c. D1 refers to the distance from the base station to the DL UE, D2 refers to the distance from the base station to the UL UE, and D3 refers to the distance between the DL UE and the UL UE.

To elaborate on the situation of FIG. 4A, the DL UE is located close to the base station and is located far from the UL UE, and D2 and D3 have relatively similar values compared with D1. The CLI signal that the DL UE receives from the UL UE is received at a similar timing to the downlink signal from the base station, and the DL UE may receive the CLI signal from the UL UE within the detection window for detecting the downlink signal from the base station.

To elaborate on the situation of FIG. 4B, the DL UE and the UL UE are both far from the base station, and the DL UE and the UL UE are located relatively close to each other. Therefore, D3 has a value relatively close to 0, and D1 and D2 have similar values. If the distance between the DL UE and the base station becomes equal to or larger than a threshold value (that if, if D1 is equal to or larger than a threshold value), signals received by the DL UE from the UL UE may be received at a timing that that comes later than the detection window for detecting downlink signals from the base station by a time interval corresponding to the CP. In such a case, the DL UE cannot receive CLI signals from the UL UE within the detection window for detecting signals from the base station. Such a threshold distance corresponds to half the distance that is proportional to the time domain length of the CP based on the subcarrier spacing (SCS) as illustrated in FIG. 4C. For example, in the case of a frequency range 1(FR1) base station having an SCS of 30 kHz, the above-described CLI detection failure problem occurs if D1 becomes equal to or larger than 345 m (that if, half the distance of 690 m which is proportional to CP 2.3 us). In the case of a frequency range 2(FR2) base station having an SCS of 120 kHz, the above-described problem occurs if D1 becomes equal to or larger than 89 m (that if, half the distance of 177 m which is proportional to CP 0.59 us).

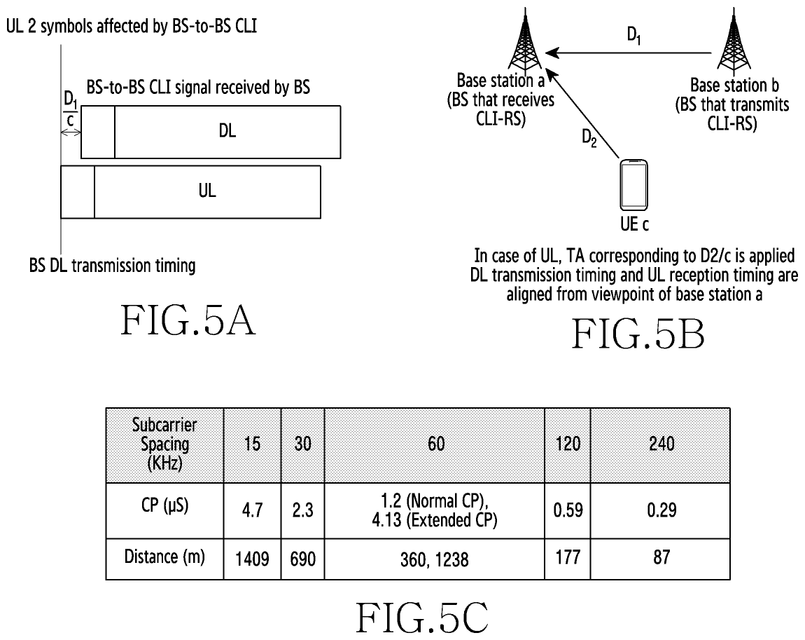

FIG. 5 is a diagram illustrating a CLI measurement process related to an embodiment of the disclosure. FIG. 5 specifically illustrates a situation in which inter-cell BS-BS CLI is measured.

FIG. 5B illustrates a situation in which base station a which operates in a full-duplex system is the serving base station of UE c, and base station a and base station b measure CLI. Base station a receives a CLI signal from base station b and measures the CLI, and the CLI signal (labeled “DL” in FIG. 4A) received by station a from station b is received at a timing that precedes the uplink signal (labeled “DL” in FIG. 4A) received from UE c by D1/c (FIG. 5A). This is because a TA of D2/c has been applied such that the uplink signal transmitted by UE c can be aligned with the frame border of base station a, and D1 refers to the distance between base station a and base station b.

In case that the distance between base station a which receives a CLI signal (or CLI-RS) in order to measure CLI and base station b which transmits the CLI signal (or CLI-RS) is sufficiently large in the case of FIG. 5 similarly to FIG. 4, that is, in case that base station a cannot receive the CLI signal from base station b within the CP interval for receiving the uplink signal from UE c, a problem of CLI measurement failure may occur.

Such a threshold distance is proportional to the time domain length of the CP based on the SCS as illustrated in FIG. 5C. For example, in the case of FR1 the SCS of which is 30 kHz, the above-mentioned CLI detection failure problem occurs if D1 becomes equal to or larger than a distance of 690 m which is proportional to CP 2.3 us. In the case of FR2 the SCS of which is 120 kHz, the above-mentioned problem occurs if D1 becomes equal to or larger than a distance of 177 m which is proportional to CP 0.59 us.

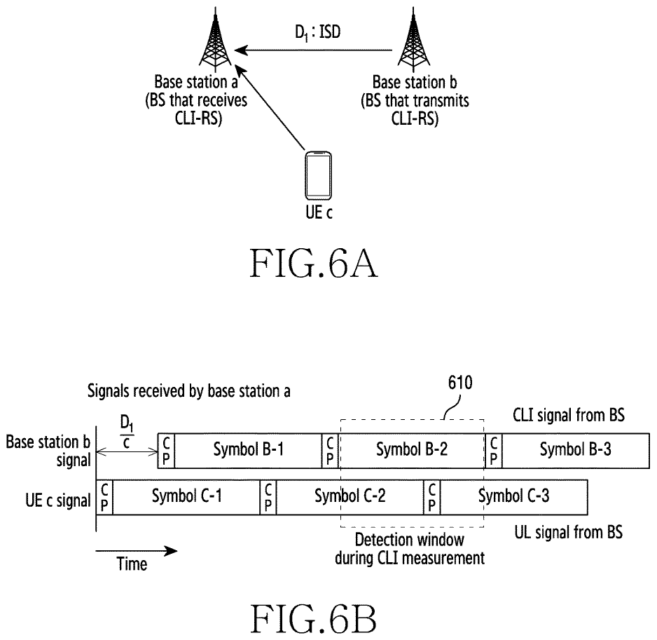

Hereinafter, various embodiments for solving the above-described problems will be described. Firstly, embodiments for improving the inter-cell BS-BS CLI measurement process will be described with reference to FIG. 6 to FIG. 17.

FIG. 6 is a diagram illustrating a CLI measurement situation according to an embodiment of the disclosure. FIG. 6 illustrates entities (or nodes) that affect the inter-cell BS-BS CLI measurement described above. FIG. 6A illustrates a situation in which base station a receives a CLI signal (or CLI-RS) transmitted by base station b from base station b, measures CLI, and receives an uplink signal from UE c that has accessed base station a. FIG. 6B illustrates signals received by base station a in the time domain in the situation of FIG. 6A.

In FIG. 6B, base station a receives a CLI signal (or CLI-RS) for CLI measurement transmitted by base station b in a detection window 610 which is a time interval corresponding to symbol B-2. That is, base station a expects to receive a CLI-RS from base station b by using a preconfigured radio resource (or CLI measurement location/CLI-RS resource), and performs CLI measurement with regard to the received CLI-RS. Meanwhile, UE c which is connected to base station a also transmits an uplink signal to base station a, and base station a receives the uplink signal from UE c in symbols C-2 and C-3 which overlap symbol B-2 in the time domain. As such, the uplink signal transmitted by UE c in symbols C-2 and C-3 has an interfering influence on the CLI measurement process performed by base station a based on the CLI signal from base station b.

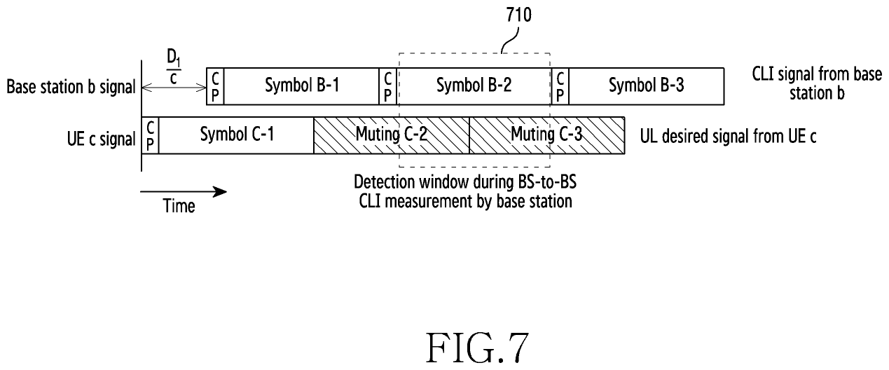

FIG. 7 is a diagram illustrating a CLI measurement method by a base station according to an embodiment of the disclosure. FIG. 7 illustrates an embodiment proposed to solve the problem described with reference to FIG. 6.

According to the embodiment proposed in FIG. 7, base station a determines a detection window 710 in order to detect a CLI-RS in symbol B-2 which is a time interval to receive a CLI-RS from base station b. In order to receive the CLI-RS transmitted by base station b within the detection window 710 and to measure CLI, base station a may configure or instruct UE c not to transmit an uplink signal in one or more symbols corresponding to the detection window 710.

The difference between the distance between base station a and base station b and the distance between base station a and UE c results in a time difference corresponding to D1/c occurs between signals received by base station a from respective nodes. Therefore, base station a may configure or instruct UE c not to transmit an uplink signal (that is, uplink muting) with regard to one or more uplink symbols corresponding to the time interval during which the CLI-RS is received from base station b. Accordingly, base station a can eliminate the influence or interference exerted on the CLI-RS received from base station b by the uplink signal from UE c, thereby efficiently measuring CLI.

Specifically, base station a performs CLI measurement based on the CLI-RS received in symbol B-2, base station a determines that the CLI-RS has been received using a sequence agreed in advance with base station b for CLI measurement, and base station a may perform CLI measurement through a process of measuring signals received in corresponding symbol B-2 (for example, CLI-reference signal received power (RSRP)). In addition, base station a may have time-frequency synchronization with base station b based on signals already received at a timing that precedes symbol B-2 (for example, in the CP of symbol B-2 or in symbol B-1 that precedes symbol B-2), and may measure CLI based on the result of such time-frequency synchronization.

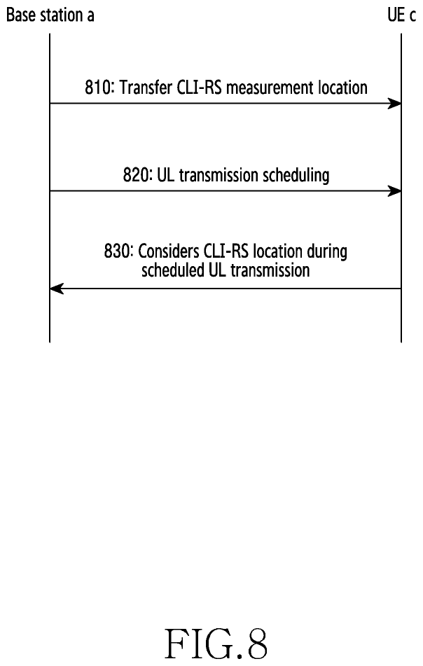

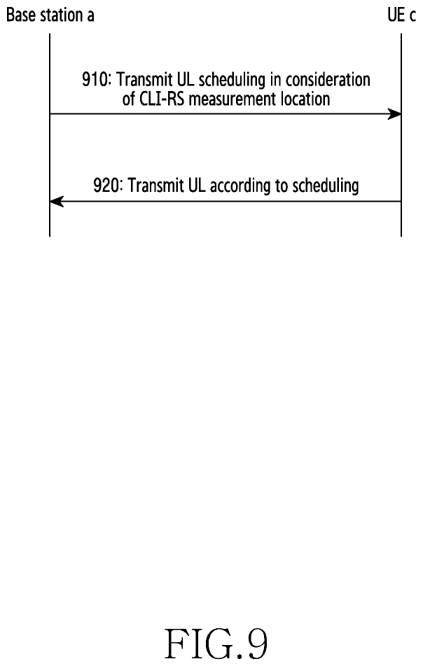

FIG. 8 and FIG. 9 are flowcharts illustrating a CLI measurement-related configuration process according to one embodiment of the disclosure. FIG. 8 and FIG. 9 illustrate a process in which base station a that measures CLI transmits CLI-related configuration information with regard to UE c that transmits an uplink signal.

Firstly, in FIG. 8, base station a transmits CLI-RS measurement location-related information to UE c (810). The CLI-RS measurement location-related information may include information regarding radio resources to be used by base station a to receive a CLI-RS, which has been determined by base station a based on an agreement with base station b.

For example, the CLI-RS measurement location-related information may include information (the period, the offset, the number of symbols, and the like) regarding time resources of one or more (resource elements (REs) used to transmit a CLI-RS, and information (the spacing, the offset, the number of subcarriers, and the like) regarding frequency resources. The above-described measurement location-related information transmission process may be performed through one of radio resource control (RRC) signaling, a medium access control (MAC) control element (CE), and downlink control information (DCI).

As another example, the CLI-RS measurement location-related information may include information regarding one or more uplink symbols determined based on CLI-RS transmission resources. That is, base station a may know in advance the number of uplink symbols corresponding to the time interval during which a CLI-RS is received from base station b, and the locational relationship (or symbol index and the like) in the time domain, based on the locational relationship with base station b and the TA value with UE c, and may transmit such uplink symbol-related information to UE c. That is, instead of transmitting CLI-RS resource-related information in connection with base station b to UE c, base station a may derive and determine uplink symbols corresponding to the CLI-RS time interval, based on CLI-RS resource-related information, and may transmit information regarding the uplink symbols to UE c. Such uplink symbol-related information may also be transmitted through one of RRC signaling, a MAC CE, and DCI.

Thereafter, base station a transmits information for scheduling uplink transmission to UE c (820). The information for scheduling may be transmitted from base station a to UE c through DCI, and can include information for allocating a predetermined time-frequency resource to the UE.

UE c transmits an uplink signal according to scheduling (830), and may perform uplink transmission based pre-received information related to the CLI-RS measurement location or uplink symbols. Specifically, UE c may transmit uplink signals except for a time interval (or one or more uplink symbols) that overlap CLI-RS resources in the time domain among uplink scheduling resources received in step 820, based on information regarding the CLI-RS measurement location or uplink symbols received from the base station. The description that uplink signals are transmitted except for a predetermined time interval may mean that puncturing is performed with regard to signals transmitted in the time interval, or rate matching is performed with regard to uplink radio resources in the time interval.

According to the embodiment proposed in FIG. 8, base station a may explicitly instruct UE c not to transmit uplink signals with regard to uplink symbols that overlap symbols for CLI measurement. The explicit instruction may mean that base station a instructs UE c not to transmit uplink symbols in the time interval even if uplink resources are scheduled for UE c with regard to the time interval.

In FIG. 9, base station a may transmit UL scheduling information to UE c in consideration of the CLI-RS measurement location (910). Base station a may predetermine radio resources (or time intervals) for receiving the CLI-RS transmitted by base station b and measuring CLI through an agreement with base station b, and base station a may schedule uplink transmission for UE c except for such radio resources (or time intervals).

Thereafter, UE c transmits an uplink signal to base station a, based on scheduling information received from base station a (920). Base station a schedules the UE's uplink transmission in consideration of the time interval for CLI measurement (that is, except for the CLI measurement time interval), and UE c may accordingly perform uplink transmission according to the scheduling information received from base station a. In such an approach, base station a implicitly informs UE c of the time interval for CLI measurement. UE a transmits an uplink signal according to the received scheduling information, and base station a schedules the operation of UE c such that no uplink signal is received from base station c in the time interval for CLI measurement, thereby facilitating the process of receiving a CLI-RS from base station b and measuring CLI.

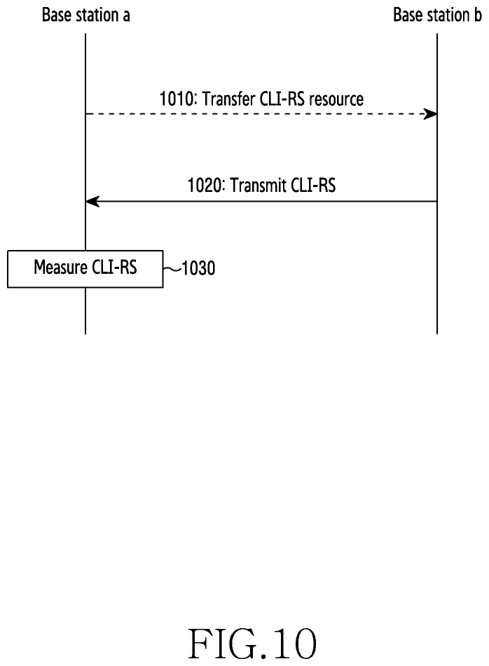

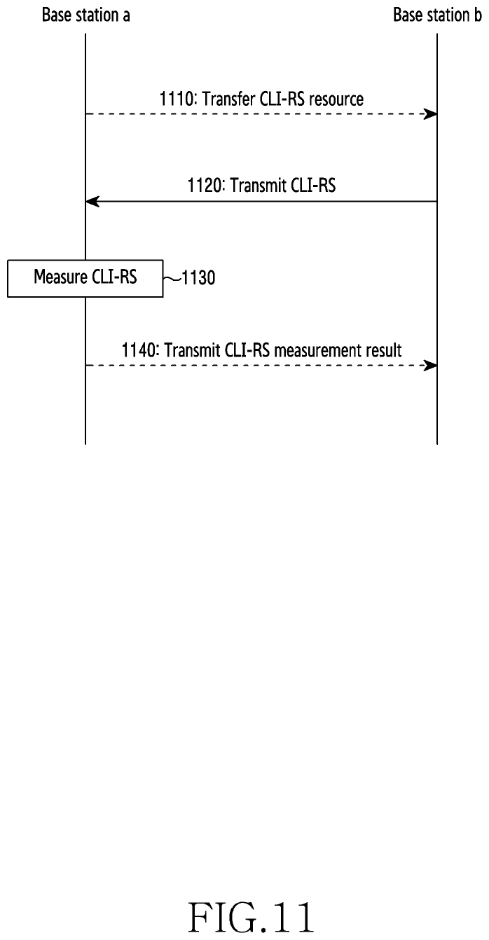

FIG. 10 and FIG. 11 are flowcharts illustrating a CLI measurement process according to an embodiment of the disclosure. FIG. 10 and FIG. 11 illustrate a signaling procedure between base station b which is an entity that transmits a CLI-RS for CLI measurement and base station a which is a CLI-RS receiving entity.

In FIG. 10, base station a transmits CLI-RS resource-related information for CLI measurement to base station b (1010). The CLI-RS resource-related information may include information regarding radio resources that may be used by base station b to transmit a CLI-RS to base station a (for example, information (the radio frame number, the subframe number, the period, the offset, the number of symbols, and the like) regarding time resources of one or more REs used to transmit a CLI-RS, information (the interval, the offset, the number of subcarriers, and the like) regarding frequency resources, information regarding the antenna port of the CLI-RS, and the like). In addition, the CLI-RS resource-related information may be information regarding a sequence for the CLI-RS transmitted by base station b (for example, the type of the sequence, the initial value of the sequence, or the seed value of the sequence).

Meanwhile, the CLI-RS resource-related information transmitted by base station a to base station b may include a process of transmitting an index value for indicating some of one or more configurations agreed in advance between base station a and base station b. For example, if multiple CLI-RS resource configurations are shared in advance between base station a and base station b, base station a may transmit an index corresponding to one of the multiple configurations to base station b, thereby indicating the CLI-RS resource configuration corresponding to the index. Such an index value may be utilized together with a lookup table or a predetermined mathematical equation agreed between the two base stations in order to specify the radio resource location or sequence of the CLI-RS.

Thereafter, base station b determines a radio resource for transmitting a CLI-RS, based on the CLI-RS resource-related information received from base station a, and transmits a CLI-RS to base station a by using the determined radio resource (1020). Base station b transmits a sequence for the CLI-RS to base station b, based on the configuration information received from base station a in step 1010, and base station a performs measurement regarding the CLI-RS received from base station b (1030).

FIG. 11 illustrates a process in which an additional procedure is performed in the embodiment of FIG. 10. The same descriptions made with reference to FIG. 10 may be applied to steps 1110, 1120, and 1130 in FIG. 11, and detailed descriptions thereof will thus be omitted.

In FIG. 11, base station a may receive a CLI-RS, may measure CLI, and may then transmit the measurement result regarding the CLI-RS (or CLI measurement result) to base station b (1140). This is because, if channel reciprocity is established between base station a and base station b, base station b may estimate CLI, based on the CLI measurement result by base station a, without a separate measurement process.

Meanwhile, the processes 1020 and 1120 in which base station b transmits a CLI-RS to base station a in FIG. 10 and FIG. 11 are for CLI measurement through a radio channel. Therefore, base station b transmits a CLI-RS through a radio channel with base station a. Meanwhile, in the processes 1010 and 1110 in which CLI-RS measurement-related resource information is transmitted between base station a and base station b and in the process 1140 in which base station a transmits the CLI measurement result to base station b, transmission may be made through the Xn interface between base stations instead of the radio channel.

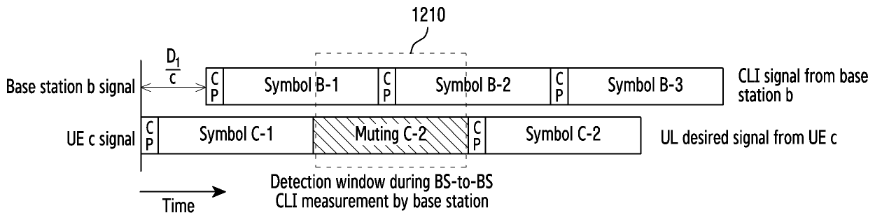

FIG. 12 is a drawing illustrating a CLI measurement method according to one embodiment of the disclosure.

FIG. 12 is another diagram illustrating signals received by base station a in the time domain in the situation described above with reference to FIG. 6A. An embodiment for minimizing the time interval (that is, muting symbol) in which UE c transmits no uplink signal will be described with reference to FIG. 12.

In FIG. 12, base station a may determine a detection window 1210 for receiving a CLI-RS from base station b so as to include one or more symbols corresponding to uplink symbols from UE c. In other words, base station a may determine that uplink symbol C-2 received from UE c is the detection window 1210 for a CLI-RS, and may receive a CLI-RS from base station b in one or more symbols (symbol B-1 and symbol B-2) included in the detection window 1210.

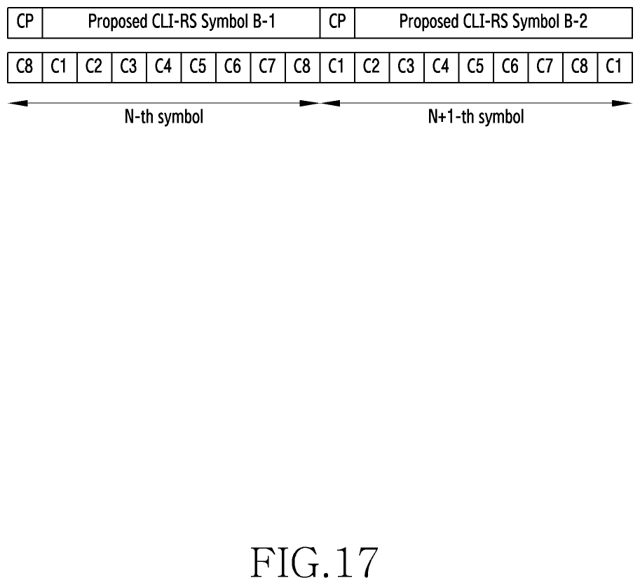

According to the embodiment proposed in FIG. 12, the detection window for the CLI-RS is determined based on the UE's uplink symbols, and the UE's muting symbol may thus be minimized to one. Meanwhile, for such operations, base station a needs to be able to detect the CLI-RS through the result of receiving signals in a part of each of two or more consecutive symbols (symbol B-1 and symbol B-2). To this end, the embodiment in FIG. 12 proposes that CLI-RS symbols be implemented in a sync-free type which does not require orthogonal frequency division multiplexing (OFDM) symbol-based decoding. The sync-free type will be described later in detail with reference to FIG. 17.

According to the embodiment proposed in FIG. 12, base station b transmits a CLI-RS to base station a through symbol B-1 and symbol B-2, and base station a receives the CLI-RS in two symbol intervals agreed with base station b and measures CLI. UE c transmits no uplink signal to base station a in uplink symbol C-2 which is a time interval corresponding to symbol B-1 and symbol B-2 (that is, symbol C-2 is a muting symbol), and base station a may thus accurately measure the CLI-RS received from base station b without the influence of interference by uplink signals from the UE.

In order to receive the CLI-RS transmitted by base station b within the detection window 1210 and to measure CLI, base station a may configure or instruct UE c not to transmit an uplink signal in one symbol (symbol C-2) corresponding to the detection window 1210.

The difference between the distance between base station a and base station b and the distance between base station a and UE c results in a time difference corresponding to D1/c occurs between signals received by base station a from respective nodes. Therefore, base station a may configure or instruct UE c not to transmit an uplink signal (that is, uplink muting) with regard a specific uplink symbol corresponding to the time interval during which the CLI-RS is received from base station b. Accordingly, base station a can eliminate the influence or interference exerted on the CLI-RS received from base station b by the uplink signal from UE c, thereby efficiently measuring CLI. The process in which base station a receive a sequence through radio resources for the CLI-RS and measures the CLI has been described above, and detailed descriptions thereof will be omitted herein.

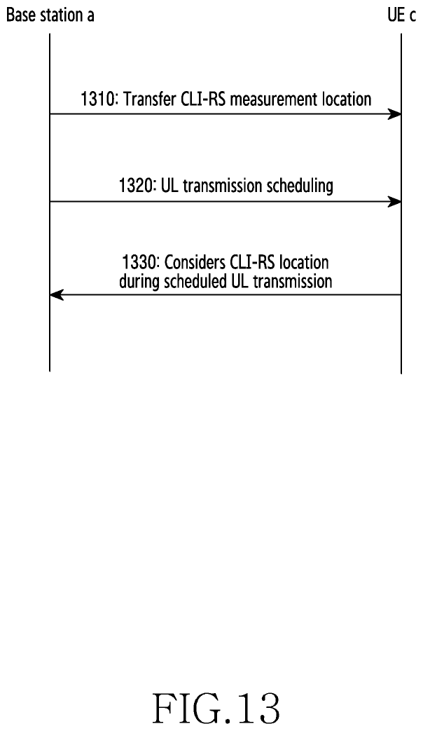

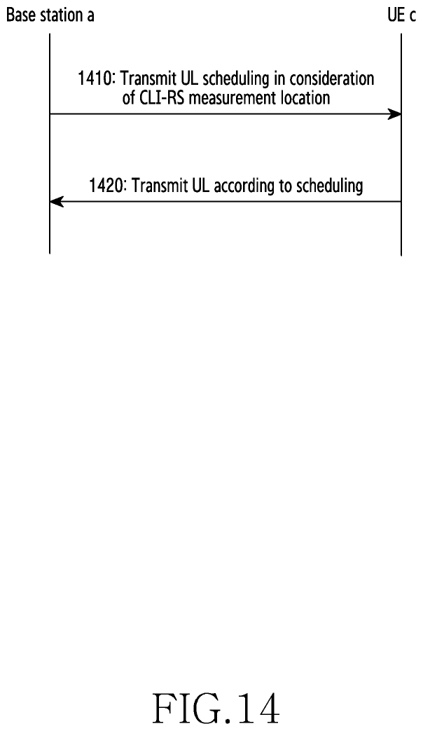

FIG. 13 and FIG. 14 are flowcharts illustrating a CLI measurement-related configuration process according to one embodiment of the disclosure. FIG. 13 and FIG. 14 illustrate a process in which base station a that measures CLI transmits CLI-related configuration information with regard to UE c that transmits an uplink signal, according to the embodiment in FIG. 12.

Firstly, in FIG. 13, base station a transmits CLI-RS measurement location-related information to UE c (1310). The CLI-RS measurement location-related information may include information regarding radio resources to be used by base station a to receive a CLI-RS, which has been determined by base station a based on an agreement with base station b.

For example, the CLI-RS measurement location-related information may include information (the period, the offset, the number of symbols, and the like) regarding time resources of one or more (resource elements (REs) used to transmit a CLI-RS, and information (the spacing, the offset, the number of subcarriers, and the like) regarding frequency resources. The above-described measurement location-related information transmission process may be performed through one of RRC signaling, a MAC CE, and DCI.

As another example, the CLI-RS measurement location-related information may include information regarding one specific uplink symbol determined based on CLI-RS transmission resources. That is, base station a may know in advance the time-domain location (or symbol index) of one uplink symbol corresponding to the time interval (that is, two consecutive symbols) in which a CLI-RS is received from base station b, based on the locational relationship with base station b and the TA value with UE c, and may transmit such uplink symbol-related information to UE c. That is, instead of transmitting CLI-RS resource-related information in connection with base station b to UE c, base station a may derive and determine the uplink symbol corresponding to the CLI-RS time interval, based on CLI-RS resource-related information, and may transmit information regarding the uplink symbol to UE c. Such uplink symbol-related information may also be transferred through one of RRC signaling, a MAC CE, and DCI.

Thereafter, base station a transmits information for scheduling uplink transmission to UE c (1320). The information for scheduling may be transmitted from base station a to UE c through DCI, and can include information for allocating a predetermined time-frequency resource to the UE.

UE c transmits an uplink signal according to scheduling (1330), and may perform uplink transmission based pre-received information related to the CLI-RS measurement location or uplink symbols. Specifically, UE c may transmit uplink signals except for a time interval (or specific uplink symbol) that overlap CLI-RS resources in the time domain among uplink scheduling resources received in step 1320, based on information regarding the CLI-RS measurement location or uplink symbols received from the base station. The description that uplink signals are transmitted except for a predetermined time interval may mean that puncturing is performed with regard to signals transmitted in the time interval, or rate matching is performed with regard to uplink radio resources in the time interval.

According to the embodiment proposed in FIG. 13, base station a may explicitly instruct UE c not to transmit uplink signals with regard to uplink symbols that overlap symbols for CLI measurement. The explicit instruction may mean that base station a instructs UE c not to transmit uplink symbols in the time interval even if uplink resources are scheduled for UE c with regard to the time interval.

In FIG. 14, base station a may transmit UL scheduling information to UE c in consideration of the CLI-RS measurement location (1410). Base station a may predetermine radio resources (or time intervals) for receiving the CLI-RS transmitted by base station b and measuring CLI through an agreement with base station b, and base station a may schedule uplink transmission for UE c except for such radio resources (or time intervals).

Thereafter, UE c transmits an uplink signal to base station a, based on scheduling information received from base station a (1420). Base station a schedules the UE's uplink transmission in consideration of the time interval for CLI measurement (that is, except for the CLI measurement time interval), and UE c may accordingly perform uplink transmission according to the scheduling information received from base station a. In such an approach, base station a implicitly informs UE c of the time interval for CLI measurement. UE a transmits an uplink signal according to the received scheduling information, and base station a schedules the operation of UE c such that no uplink signal is received from base station c in the time interval for CLI measurement, thereby facilitating the process of receiving a CLI-RS from base station b and measuring CLI.

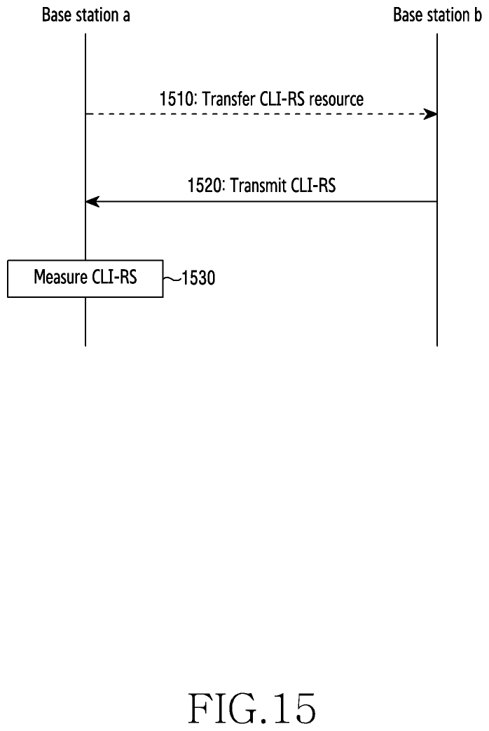

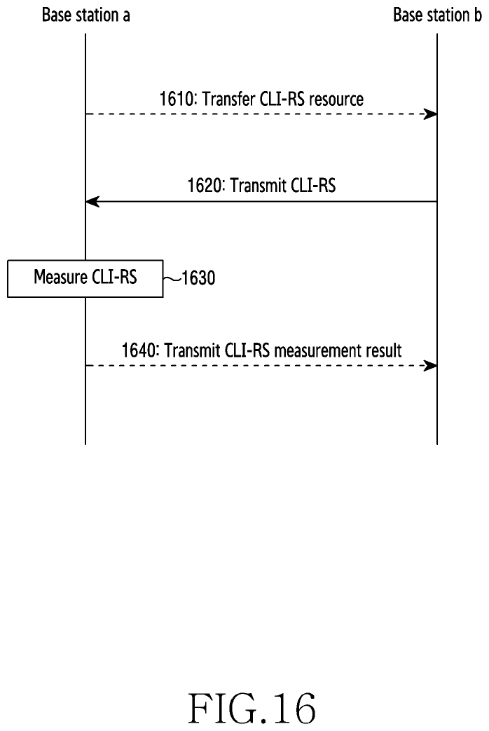

FIG. 15 and FIG. 16 are flowcharts illustrating a CLI measurement process according to an embodiment of the disclosure. FIG. 15 and FIG. 16 illustrate a signaling procedure between base station b which is an entity that transmits a CLI-RS for CLI measurement and base station a which is a CLI-RS receiving entity.

In FIG. 15, base station a transmits CLI-RS resource-related information for CLI measurement to base station b (1510). The CLI-RS resource-related information may include information regarding radio resources that may be used by base station b to transmit a CLI-RS to base station a (for example, information (the radio frame number, the subframe number, the period, the offset, the number of symbols, and the like) regarding time resources of two or more REs (or consecutive REs) used to transmit a CLI-RS, information (the interval, the offset, the number of subcarriers, and the like) regarding frequency resources, information regarding the antenna port of the CLI-RS, and the like). In addition, the CLI-RS resource-related information may be information regarding a sequence for the CLI-RS transmitted by base station b (for example, the type of the sequence, the initial value of the sequence, or the seed value of the sequence).

Meanwhile, the CLI-RS resource-related information transmitted by base station a to base station b may include a process of transmitting an index value for indicating some of one or more configurations agreed in advance between base station a and base station b. For example, if multiple CLI-RS resource configurations are shared in advance between base station a and base station b, base station a may transmit an index corresponding to one of the multiple configurations to base station b, thereby indicating the CLI-RS resource configuration corresponding to the index. Such an index value may be utilized together with a lookup table or a predetermined mathematical equation agreed between the two base stations in order to specify the radio resource location or sequence of the CLI-RS.

Thereafter, base station b determines a radio resource for transmitting a CLI-RS, based on the CLI-RS resource-related information received from base station a, and transmits a CLI-RS to base station a by using the determined radio resource (1520). Base station b transmits a sequence for the CLI-RS to base station b, based on the configuration information received from base station a in step 1510, and base station a performs measurement regarding the CLI-RS received from base station b (1530).

FIG. 16 illustrates a process in which an additional procedure is performed in the embodiment of FIG. 15. The same descriptions made with reference to FIG. 15 may be applied to steps 1610, 1620, and 1630 in FIG. 16, and detailed descriptions thereof will thus be omitted.

In FIG. 16, base station a may receive a CLI-RS, may measure CLI, and may then transmit the measurement result regarding the CLI-RS (or CLI measurement result) to base station b (1640). This is because, if channel reciprocity is established between base station a and base station b, base station b may estimate CLI, based on the CLI measurement result by base station a, without a separate measurement process.

Meanwhile, the processes 1520 and 1620 in which base station b transmits a CLI-RS to base station a in FIG. 15 and FIG. 16 are for CLI measurement through a radio channel. Therefore, base station b transmits a CLI-RS through a radio channel with base station a. Meanwhile, in the processes 1510 and 1610 in which CLI-RS measurement-related resource information is transmitted between base station a and base station b and in the process 1640 in which base station a transmits the CLI measurement result to base station b, transmission may be made through the Xn interface between base stations instead of the radio channel.

FIG. 17 is a diagram illustrating a CLI-RS symbol structure according to an embodiment of the disclosure. FIG. 17 illustrates a detailed a CLI-RS symbol structure in a sync-free type for implementing the embodiment described above with reference to FIG. 12.

As described above with reference to FIG. 12, in case that base station a determines a CLI-RS detection window based on uplink symbols from UE c instead of symbols from base station b, base station a receives a CLI-RS across two symbols from the symbol middle location (not the starting timing) of a specific symbol. Even in such a case, base station a needs to be able to accurately receive and decode the CLI-RS.

To this end, the CLI-RS symbol structure proposed in FIG. 17 has time-domain characteristics in that CLI-RS decoding is possible even if base station a determines any location in a symbol as the decoding starting location. To this end, base station b may configure two consecutive symbols such that the preceding CLI-RS symbol and the following CLI-RS symbol have a cyclic-shift relationship corresponding to the CP length with each other. That is, CLI-RS symbol B-1 is divided in the time domain so as to correspond to an integer multiple of the CP length, and signal “C1” is transmitted such that the CP of symbol B-2 that follows symbol B-1 has a cyclic-shift relationship from “C8” corresponding to the CP of symbol B-1. For example, in case that the CP of a specific symbol has a time length corresponding to ⅛ of the part other than the CP, base station b may transmit signal C8 in the CP of symbol B-1 and may transmit signals C1 to C8 in the part other than the CP. Base station b may then transmit signal “C1” which has a cyclic-shift relationship with respect to the CP of symbol B-1 in symbol B-2 that follows symbol B-1. In case that a CLI-RS is transmitted by configuring a sequence in this manner, base station a, upon receiving the CLI-RS, can decode all signals C1 to C8 no matter what timing in the symbol interval of symbol B-1 is determined to be the detection window.

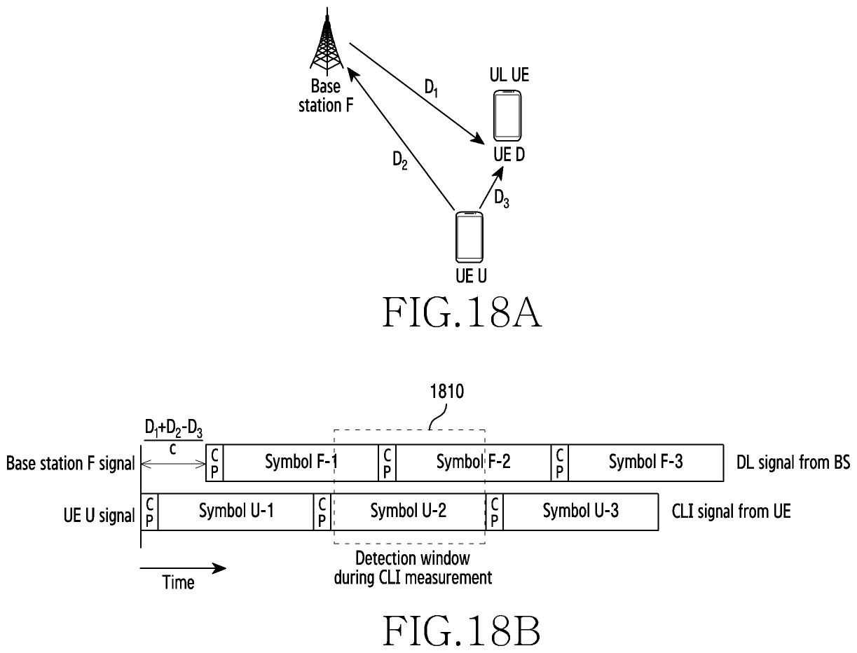

Hereinafter, an embodiment for improving the intra-cell UE-UE CLI measurement process will be described with reference to FIG. 18 to FIG. 23.

FIG. 18 is a drawing illustrating a CLI measurement situation according to one embodiment of the disclosure.

FIG. 18 is a diagram illustrating a CLI measurement situation according to an embodiment of the disclosure. FIG. 18 illustrates entities (or nodes) that affect intra-cell UE-UE CLI measurement. FIG. 18A illustrates a situation in which UE D receives a CLI signal (or a CLI-RS) transmitted by UE U, measures CLI, and receives a downlink signal from base station F which has been accessed thereby, and FIG. 18B illustrates signals received by UE D in the time domain in the situation of FIG. 18A.

In FIG. 18B, UE D receives a CLI signal (or a CLI-RS) for CLI measurement transmitted by UE U in a detection window 1810, which is a time interval corresponding to symbol U-2. That is, UE D expects to receive a CLI-RS from UE U by using a preconfigured radio resource (or CLI measurement location/CLI-RS resource), and performs CLI measurement with regard to the received CLI-RS. Meanwhile, base station F which supports UE D also transmits a downlink signal to UE D, and UE D receives the downlink signal from base station F in symbols F-2 and F-3 which overlap symbol U-2 in the time domain. As such, the downlink signal transmitted by base station F in symbols F-2 and F-3 has an interfering influence on the CLI measurement process performed by UE D based on the CLI signal from UE U.

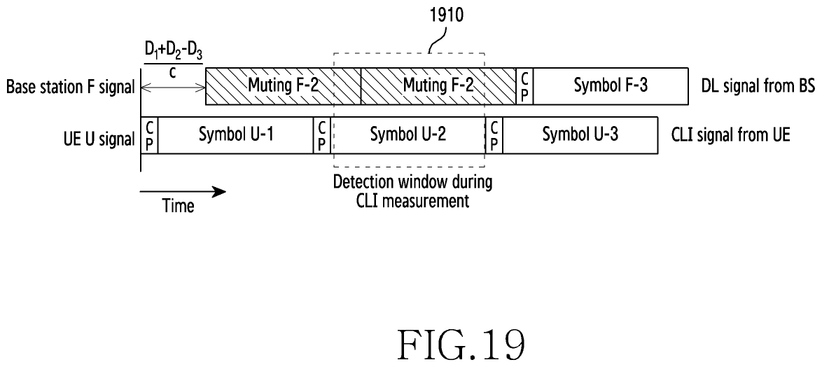

FIG. 19 is a diagram illustrating a CLI measurement method by a UE according to an embodiment of the disclosure. FIG. 19 illustrates an embodiment proposed to solve the problem described with reference to FIG. 18.

According to the embodiment proposed in FIG. 19, UE D determines a detection window 1910 to detect a CLI-RS in symbol U-2 which is a time interval to receive a CLI-RS is received from UE U. In order to measure the CLI by receiving the CLI-RS transmitted by UE U within the detection window 1910, UE D may configure or instruct base station F not to transmit a downlink signal in one or more symbols corresponding to the detection window 1910.

The difference between the distance between UE D and UE U and the distance between UE D and base station F results in a time difference corresponding to (D1+D2−D3)/c between signals received by UE D from respective nodes. Therefore, UE D may request base station F not to transmit a downlink signal (that is, downlink muting) with regard to one or more uplink symbols corresponding to the time interval during which the CLI-RS is received from UE U. Alternatively, UE D may expect that base station F will transmit no downlink signal with regard to the time interval corresponding to the one or more uplink symbols. Accordingly, UE D can eliminate the influence or interference exerted on the CLI-RS received from UE U by the downlink signal from base station F, thereby efficiently measuring CLI.

Specifically, UE D performs CLI measurement based on the CLI-RS received in symbol U-2, UE D determines that the CLI-RS has been received using a sequence agreed in advance with UE U for CLI measurement, and UE D may perform CLI measurement through a process of measuring signals received in corresponding symbol U-2 (for example, CLI-reference signal received power (RSRP)). In addition, UE D may have time-frequency synchronization with UE U based on signals already received at a timing that precedes symbol U-2 (for example, in the CP of symbol U-2 or in symbol U-1 that precedes symbol U-2), and may measure CLI based on the result of such time-frequency synchronization.

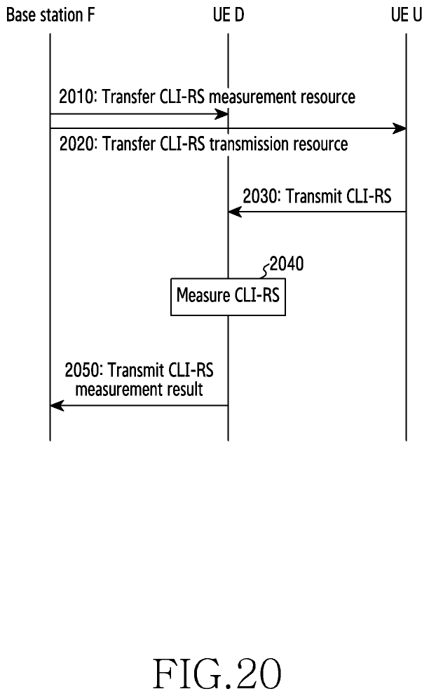

FIG. 20 is a flowchart illustrating a CLI measurement-related configuration process and a measurement process according to an embodiment of the disclosure. FIG. 20 illustrates a series of processes in which UE D configured to measure CLI receives a CLI-RS from UE U in consideration of a downlink signal from base station F configured to transmit a downlink signal.

In FIG. 20, base station F transmits CLI-RS measurement location-related information to UE D (2010). The CLI-RS measurement location-related information may include information regarding resources of the CLI-RS, and may include information regarding radio resources that may be used by UE D to receive a CLI-RS from UE U (for example, information (the radio frame number, the subframe number, the period, the offset, the number of symbols, and the like) regarding time resources of two or more REs used to transmit a CLI-RS, information (the interval, the offset, the number of subcarriers, and the like) regarding frequency resources, information regarding the antenna port of the CLI-RS, and the like). In addition, the CLI-RS resource-related information may include information regarding a sequence for the CLI-RS to be received by UE D from UE U (for example, the type of the sequence, the initial value of the sequence, or the seed value of the sequence).

Thereafter, base station F transmits CLI-RS transmission-related information to the UE U (2020). The CLI-RS transmission-related information may include information regarding radio resources to be used by UE U to transmit a CLI-RS to UE D, and may include, for example, information (the radio frame number, the subframe number, the period, the offset, the number of symbols, and the like) regarding time resources of two or more REs used to transmit a CLI-RS, information (the interval, the offset, the number of subcarriers, and the like) regarding frequency resources, information regarding the antenna port of the CLI-RS, and the like. In addition, the CLI-RS transmission-related information may include information regarding a sequence for the CLI-RS to be transmitted by UE U to UE D (for example, the type of the sequence, the initial value of the sequence, or the seed value of the sequence). Steps 2010 and 2020 may be performed through one of RRC signaling, a MAC CE, and DCI transmitted by base station F.

The CLI-RS measurement location-related information transmitted by base station F to UE D and the CLI-RS transmission-related information transmitted to UE U may include a process of transmitting an index value for indicating some of multiple configurations shared in advance between base station F, UE D, and UE U. For example, if multiple CLI-RS resource configurations are shared in advance between base station F, UE D, and UE U, base station F may transmit an index corresponding to one of the multiple configurations to each of UE D and/or UE U, thereby indicating the CLI-RS-related configuration corresponding to the index. Such an index value may be utilized together with a lookup table or a predetermined mathematical equation agreed between the base station and the two UEs in order to specify the radio resource location or sequence of the CLI-RS.

UE U transmits a CLI-RS to UE D, based on CLI-RS transmission-related information received from base station F (2030). UE D receives the CLI-RS from UE U, based on CLI-RS measurement location-related information received from base station F, measures CLI with regard to the received CLI-RS (2040), and transmits the CLI-RS measurement result or CLI measurement result to base station F (2050).

In the process in which UE D receives the CLI-RS and performs CLI measurement, UE D may expect that no downlink signal will be received from base station F. That is, UE D may receive a CLI-RS from UE U based on an assumption that base station F will transmit no downlink signal in the time interval (two consecutive downlink symbols) for receiving a CLI-RS according to the CLI-RS measurement location-related information received from base station F (that is, downlink muting).

The above description that UE D knows that no downlink signal will be received from base station F may mean that UE D operates based on a determination that no downlink signal will be received from base station F because, even if downlink reception has been scheduled through resources that overlap radio resources for receiving a CLI-RS from UE U, the CLI-RS needs to be received through the scheduled resources. That is, UE D may perform rate matching assuming that no downlink signal will be received in intervals in which radio resource for CLI-RS reception and resources having scheduled downlink reception overlap, and may also receive the CLI-RS assuming that the base station has performed puncturing with regard to corresponding radio resources.

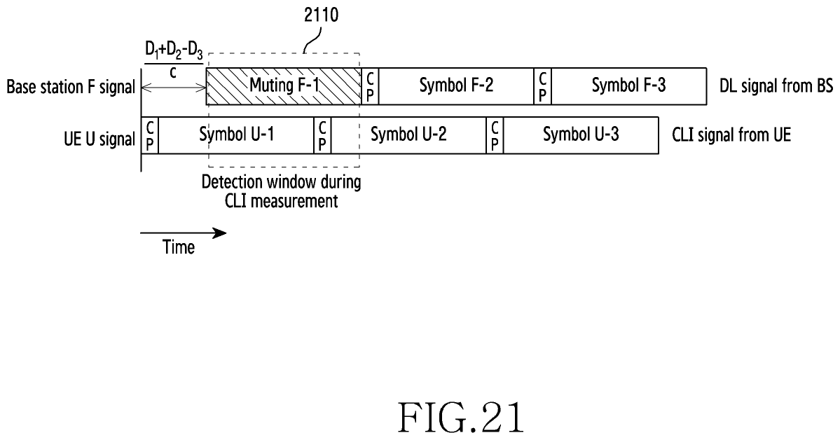

FIG. 21 is a drawing illustrating a CLI measurement method according to one embodiment of the disclosure.

FIG. 21 is another diagram illustrating signals received by UE D in the time domain in the situation of FIG. 18A. An embodiment for minimizing the time interval (that is, a muting symbol) in which base station F transmits no downlink signal will be described with reference to FIG. 21.

In FIG. 21, UE D may determine a detection window 2110 for receiving a CLI-RS from UE U so as to include one or more symbols corresponding to downlink symbols from base station F. In other words, UE D may determine that downlink symbol F-1 received from base station F is the detection window 2110 for a CLI-RS, and may receive a CLI-RS from UE U in one or more symbols (symbol U-1 and symbol U-2) included in the detection window 2110.

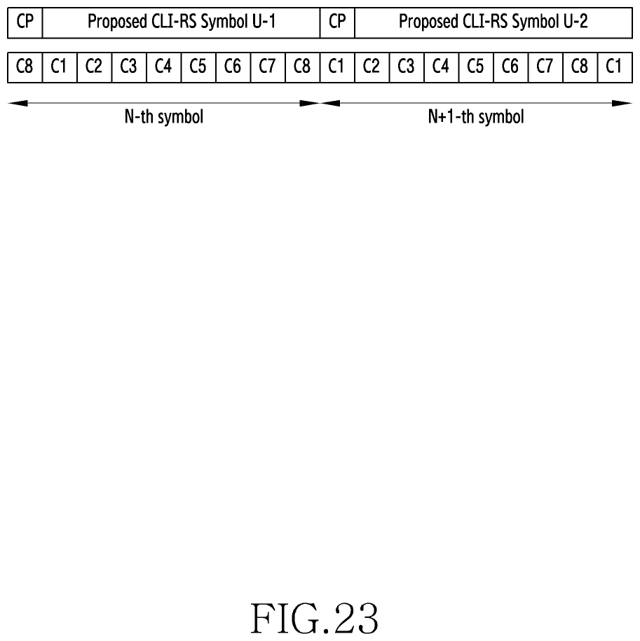

According to the embodiment proposed in FIG. 21, the detection window for the CLI-RS is determined based on the base station's downlink symbols, and the base station's downlink muting symbol may thus be minimized to one. Meanwhile, for such operations, UE D needs to be able to detect the CLI-RS through the result of receiving signals in a part of each of two or more consecutive symbols (symbol U-1 and symbol U-2). To this end, the embodiment in FIG. 21 proposes that CLI-RS symbols be implemented in a sync-free type which does not require OFDM symbol-based decoding, which will be described later in detail with reference to FIG. 23.

According to the embodiment proposed in FIG. 21, UE U transmits a CLI-RS to UE D through symbol U-1 and symbol U-2, and UE D receives the CLI-RS in two symbol intervals agreed with UE U and measures CLI. Base station F transmits no downlink signal to UE D in downlink symbol F-2 which is a time interval corresponding to symbol U-1 and symbol U-2 (that is, symbol F-2 is a muting symbol), and UE D may thus accurately measure the CLI-RS received from UE U without the influence of interference by downlink signals from base station F.

In connection with receiving the CLI-RS transmitted by UE U within the detection window 2110 and measuring CLI, UE D may expect or determine that base station F will transmit no downlink signal in one symbol (symbol F-2) corresponding to the detection window 2110.

The difference between the distance between UE D and UE U and the distance between UE D and base station F results in a time difference corresponding to (D1+D2−D3)/c between signals received by UE D from respective nodes. Therefore, UE D may receive a CLI-RS based on an assumption or a premise that base station F will transmit no downlink signal (that is, downlink muting) with regard a specific downlink symbol corresponding to the time interval during which the CLI-RS is received from UE U. Accordingly, UE D can eliminate the influence or interference exerted on the CLI-RS received from UE U by the downlink signal from base station F, thereby efficiently measuring CLI. The process in which UE D receives a sequence through radio resources for the CLI-RS and measures the CLI has been described above, and detailed descriptions thereof will be omitted herein.

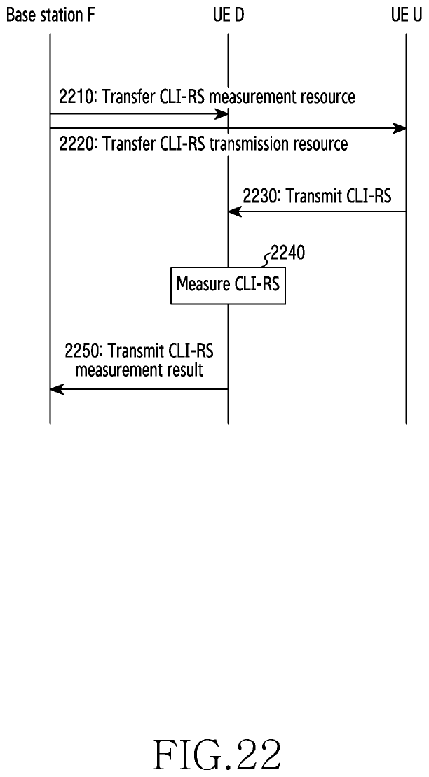

FIG. 22 is a flowchart illustrating a CLI measurement-related configuration process and a measurement process according to one embodiment of the disclosure.

FIG. 22 is a flowchart illustrating a CLI measurement-related configuration process and a measurement process according to an embodiment of the disclosure. FIG. 22 illustrates a series of processes in which UE D configured to measure CLI receives a CLI-RS from UE U in consideration of a downlink signal from base station F configured to transmit a downlink signal.

In FIG. 22, base station F transmits CLI-RS measurement location-related information to UE D (2210). The CLI-RS measurement location-related information may include information regarding resources of the CLI-RS, and may include information regarding radio resources that may be used by UE D to receive a CLI-RS from UE U (for example, information (the radio frame number, the subframe number, the period, the offset, the number of symbols, and the like) regarding time resources of two consecutive REs used to transmit a CLI-RS, information (the interval, the offset, the number of subcarriers, and the like) regarding frequency resources, information regarding the antenna port of the CLI-RS, and the like). In addition, the CLI-RS resource-related information may include information regarding a sequence for the CLI-RS to be received by UE D from UE U (for example, the type of the sequence, the initial value of the sequence, or the seed value of the sequence).

Thereafter, base station F transmits CLI-RS transmission-related information to the UE U (2220). The CLI-RS transmission-related information may include information regarding radio resources to be used by UE U to transmit a CLI-RS to UE D, and may include, for example, information (the radio frame number, the subframe number, the period, the offset, the number of symbols, and the like) regarding time resources of two consecutive REs used to transmit a CLI-RS, information (the interval, the offset, the number of subcarriers, and the like) regarding frequency resources, information regarding the antenna port of the CLI-RS, and the like. In addition, the CLI-RS transmission-related information may include information regarding a sequence for the CLI-RS to be transmitted by UE U to UE D (for example, the type of the sequence, the initial value of the sequence, or the seed value of the sequence). Steps 2210 and 2220 described above may be performed through one of RRC signaling, a MAC CE, and DCI transmitted by base station F.

The CLI-RS measurement location-related information transmitted by base station F to UE D and the CLI-RS transmission-related information transmitted to UE U may include a process of transmitting an index value for indicating some of multiple configurations shared in advance between base station F, UE D, and UE U. For example, if multiple CLI-RS resource configurations are shared in advance between base station F, UE D, and UE U, base station F may transmit an index corresponding to one of the multiple configurations to each of UE D and/or UE U, thereby indicating the CLI-RS-related configuration corresponding to the index. Such an index value may be utilized together with a lookup table or a predetermined mathematical equation agreed between the base station and the two UEs in order to specify the radio resource location or sequence of the CLI-RS.

UE U transmits a CLI-RS to UE D, based on CLI-RS transmission-related information received from base station F (2230). UE D receives the CLI-RS from UE U, based on CLI-RS measurement location-related information received from base station F, measures CLI with regard to the received CLI-RS (2240), and transmits the CLI-RS measurement result or CLI measurement result to base station F (2250).

In the process in which UE D receives the CLI-RS and performs CLI measurement, UE D may expect that no downlink signal will be received from base station F. That is, UE D may receive a CLI-RS from UE U based on an assumption that base station F will transmit no downlink signal (that is, downlink muting) in the time interval for receiving a CLI-RS according to the CLI-RS measurement location-related information received from base station F (that is, in the time interval corresponding to one specific downlink symbol).

The above description that UE D knows that no downlink signal will be received from base station F may mean that UE D operates based on a determination that no downlink signal will be received from base station F because, even if downlink reception has been scheduled through resources that overlap radio resources for receiving a CLI-RS from UE U, the CLI-RS needs to be received through the scheduled resources. That is, UE D may perform rate matching assuming that no downlink signal will be received in intervals in which radio resource for CLI-RS reception and resources having scheduled downlink reception overlap, and may also receive the CLI-RS assuming that the base station has performed puncturing with regard to corresponding radio resources.

FIG. 23 is a diagram illustrating a CLI-RS symbol structure according to an embodiment of the disclosure. FIG. 23 illustrates a detailed a CLI-RS symbol structure in a sync-free type for implementing the embodiment described above with reference to FIG. 21.

As described above with reference to FIG. 21, in case that UE D determines a CLI-RS detection window based on downlink symbols from base station F instead of symbols from UE U, UE D receives a CLI-RS across two symbols from the symbol middle location (not the starting timing) of a specific symbol. Even in such a case, UE D needs to be able to accurately receive and decode the CLI-RS.

To this end, the CLI-RS symbol structure proposed in FIG. 23 has time-domain characteristics in that CLI-RS decoding is possible even if UE D determines any location in a symbol as the decoding starting location. To this end, UE U may transmit a CLI-RS such that, among two consecutive symbols, such that the preceding CLI-RS symbol and the following CLI-RS symbol have a cyclic-shift relationship corresponding to the CP length with each other. That is, CLI-RS symbol U-1 is divided in the time domain so as to correspond to an integer multiple of the CP length, and signal “C1” is transmitted such that the CP of symbol U-2 that follows symbol U-1 has a cyclic-shift relationship from “C8” corresponding to the CP of symbol U-1. For example, in case that the CP of a specific symbol has a time length corresponding to ⅛ of the part other than the CP, UE U may transmit signal C8 in the CP of symbol U-1 and may transmit signals C1 to C8 in the part other than the CP. UE U may then transmit signal “C1” which has a cyclic-shift relationship with respect to the CP of symbol U-1 in symbol U-2 that follows symbol U-1. In case that a CLI-RS is transmitted by configuring a sequence in this manner, UE D, upon receiving the CLI-RS, can decode all signals C1 to C8 no matter what timing in the symbol interval of symbol U-1 is determined to be the detection window.

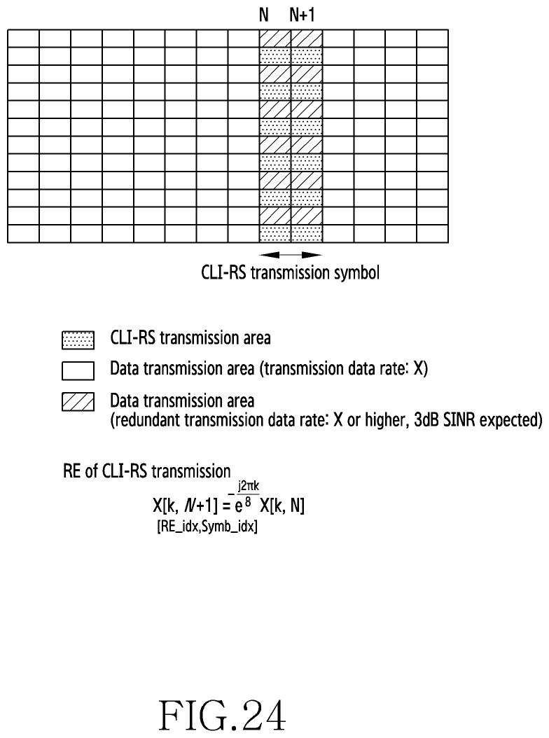

FIG. 24 is a diagram illustrating a radio resource structure related to a CLI-RS according to an embodiment of the disclosure. An embodiment in which data is multiplexed when a CLI-RS is transmitted through the sync-free symbol structure proposed in FIG. 17 and FIG. 23 will be described with reference to FIG. 24.

As previously described with reference to FIG. 17, a specific base station transmits a CLI-RS in a sync-free symbol for inter-base station CLI measurement, and as previously described with reference to FIG. 23, a specific UE transmits a CLI-RS in a sync-free symbol for inter-UE CLI measurement. The example in FIG. 24 will be described in detail. In case that a CLI-RS is transmitted in symbol N and symbol N+1, symbol N and symbol N+1 are cyclic-shifted along the time axis by the CP length, as previously described. In FIG. 24, a mathematical formula is used to indicate a cyclic shift relationship between received signals of two REs in which a CLI-RS is received.

Meanwhile, in case that a CLI-RS is transmitted in two or more consecutive symbols in the sync-free manner, an RE for the CLI-RS and an RE for transmitting data (for example, a physical downlink shared channel (PDSCH) or a physical uplink shared channel (PUSCH)) may be multiplexed in the frequency domain (that is, frequency division multiplexing (FDM)) on the radio resource grid.

As illustrated in FIG. 24, in case that a CLI-RS is transmitted in two consecutive symbols, non-RS data (PDSCH or PUSCH) may be multiplexed and transmitted in two symbols that are adjacent to two symbols in which the CLI-RS is received, in the frequency domain. There is also a cyclic shift relationship established between two data REs that have an FDM relationship with CLI-RS REs. Accordingly, a base station (in the case of FIG. 17) or a UE (in the case of FIG. 23) which receives data in the two data REs may combine and decode the data received in the two consecutive REs. This may advantageously increase the SINR of the data received by the base station or the UE in REs of two consecutive symbols. Particularly, when the location of the CLI-RS RE is known between the CLI-RS transmitting entity and the CLI-RS receiving entity, it may also be known together that the antenna port of the CLI-RS is identical to or corresponds to the antenna port of the demodulation reference signal (DMRS) regarding the data channel. By sharing such antenna port relationships, efficient channel estimation may be performed through the DMRS during data channel decoding.

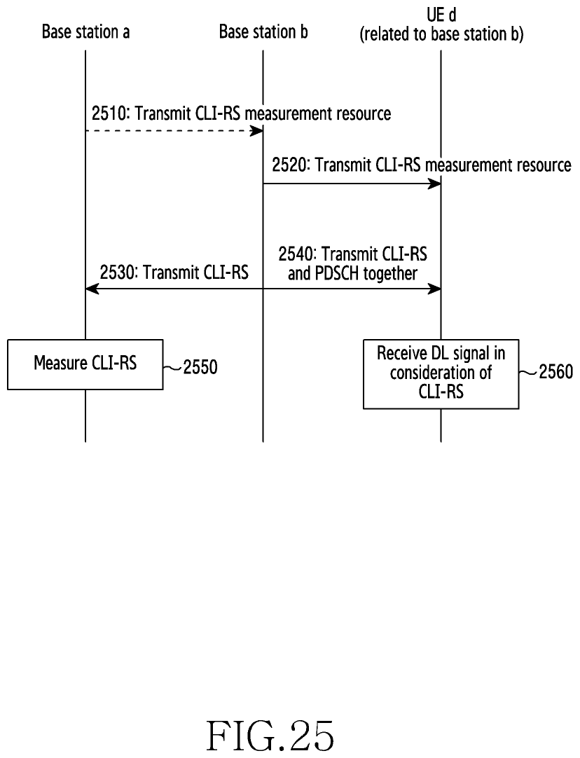

FIG. 25 is a diagram illustrating a CLI measurement-related configuration process and a measurement process according to an embodiment of the disclosure. FIG. 25 illustrates a process of applying the embodiment in FIG. 24 in the process of measuring inter-base station CLI.

In FIG. 25, base station a transmits configuration information related to CLI-RS measurement resources to base station b (2510), and base station b transmits configuration information related to CLI-RS measurement resources to UE d which is connected to base station b (2520). The configuration information transmitted by base station a to base station b and the configuration information transmitted by base station b to UE d may include information for indicating or identifying the same radio resources for CLI-RS transmission.

Base station b transmits a CLI-RS for inter-base station CLI measurement to base station a, based on the information received from base station a (2530). Upon receiving the CLI-RS from base station b, base station a measures the CLI (2550). Detailed descriptions given above may be applied to a series of processes in which base stations receive the CLI-RS and measure the CLI.

Meanwhile, when base station b transmits a CLI-RS in two consecutive symbols according to the embodiment described above with reference to FIG. 17, base station b may transmit downlink data (that is, PDSCH) to UE d (2540). According to the embodiment described with reference to FIG. 24, REs of the CLI-RS transmitted by base station b and PDSCH REs may have an FDM relationship with each other. UE d has already received configuration information related to CLI-RS measurement resources from base station b, and may thus receive the PDSCH in consideration of the received configuration information (2560). The description that UE d receives the PDSCH in consideration of the configuration information means that UE d may receive the PDSCH after recognizing information regarding CLI-RS transmission REs of base station b and recognizing that CLI-RS transmission REs and PDSCH REs have in an FDM relationship.

Scheduling information of the PDSCH transmitted by base station b to UE d is not separately illustrated in FIG. 25. If UE d has received scheduling information of the PDSCH from base station b before receiving CLI-RS configuration information (that is, before 2510), UE d may determine that the CLI-RS RE location has been rate-matched when receiving the scheduled PDSCH. On the other hand, if UE d has received scheduling information of the PDSCH from base station b after receiving CLI-RS configuration information (that is, after 2510), UE d may determine that the CLI-RS RE location has been punctured when receiving the scheduled PDSCH.

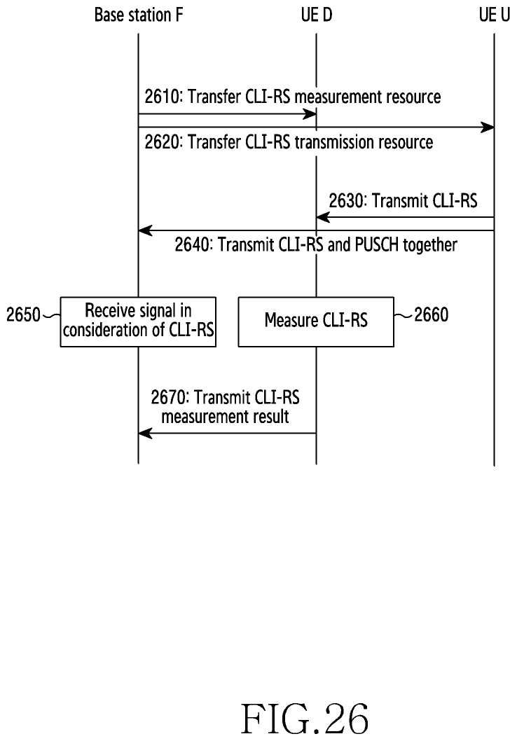

FIG. 26 is a diagram illustrating a CLI measurement-related configuration process and a measurement process according to an embodiment of the disclosure. FIG. 26 illustrates a process of applying the embodiment in FIG. 24 in the process of measuring inter-UE CLI.

In FIG. 26, base station F transmits configuration information related to CLI-RS measurement resources to UE D (2610), and base station F transmits configuration information related to CLI-RS transmission resources to UE D (2620). The configuration information transmitted by base station F to UE D and the configuration information transmitted to UE U may include information for indicating or identifying the same radio resources for CLI-RS transmission between UE D and UE U.

UE U transmits a CLI-RS for inter-UE CLI measurement to UE D, based on the information received from base station F (2630). Upon receiving the CLI-RS from UE U, UE D measures the CLI (2660), and reports the CLI-RS measurement result or CLI measurement result to base station F (2670). Detailed descriptions given above may be applied to a series of processes in which UEs receive the CLI-RS and measure the CLI.

Meanwhile, when UE U transmits a CLI-RS in two consecutive symbols according to the embodiment described above with reference to FIG. 23, UE U may transmit uplink data (that is, PUSCH) to base station F (2640). According to the embodiment described with reference to FIG. 24, REs of the CLI-RS transmitted by UE U and PUSCH REs may have an FDM relationship with each other. Base station F has already transmitted configuration information related to CLI-RS transmission resources to UE U and thus already has information regarding CSI-RS REs transmitted by UE U, and may receive the PUSCH transmitted by UE U, based thereon (2650). The description that base station F receives the PUSCH in consideration of the information regarding CSI-RS REs means that base station F may receive the PUSCH after recognizing information regarding CLI-RS transmission REs of UE U and recognizing that CLI-RS transmission REs and PDSCH REs have in an FDM relationship.

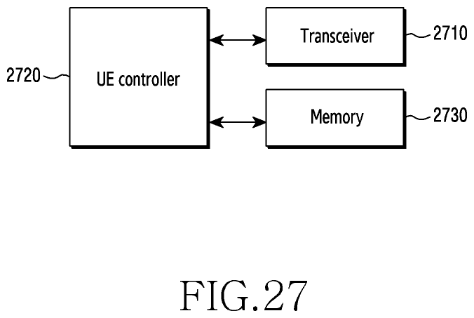

FIG. 27 is a diagram illustrating the structure of a UE according to an embodiment of the disclosure. Referring to FIG. 27, the UE may include a transceiver 2710, a UE controller 2720, and a memory 2730. In the disclosure, the UE controller 2720 may be defined as a circuit or an application-specific integrated circuit or at least one processor.

The transceiver 2710 transmits/receives signals with a base station or another UE. The transceiver 2710 may, for example, receive a CLI-RS from another UE, transmit a CLI-RS to another UE, receive a downlink signal from a base station, or transmit an uplink signal to a base station. The transceiver 2710 may be implemented as a radio frequency (RF) unit including a modem.

The UE controller 2720 may control overall operations of the UE according to embodiments proposed in the disclosure. For example, the UE controller 2720 may control the transceiver 2710 and the memory 2730 so as to perform operations according to embodiments described above with reference to the drawings.

The memory 2730 may store at least one from among information transmitted/received through the transceiver 2710 and information generated through the UE controller 2720.

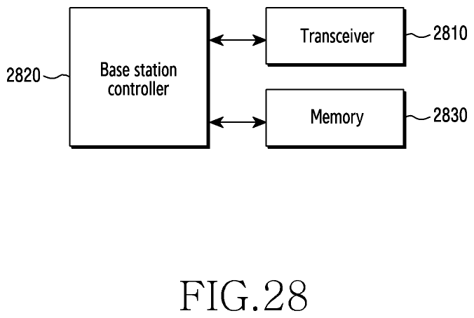

FIG. 28 is a diagram illustrating the structure of a base station according to an embodiment of the disclosure. Referring to FIG. 28, the base station may include a transceiver 2810, a base station controller 2820, and a memory 2830. In the disclosure, the base station controller 2820 may be defined as a circuit or an application-specific integrated circuit or at least one processor.

The transceiver 2810 may transmit/receive signals with a UE or another base station. The transceiver 2810 may, for example, receive a CLI-RS from another base station, transmit a CLI-RS to another base station, receive an uplink signal from a UE, or transmit a downlink signal to a UE. The transceiver 2810 may be implemented as an RF unit including a modem.

The base station controller 2820 may control overall operations of the base station according to embodiments proposed in the disclosure. For example, the base station controller 2820 may control the transceiver 2810 and the memory 2830 so as to perform operation according to embodiments described above with reference to the drawings.

The memory 2830 may store at least one from among information transmitted/received through the transceiver 2810 and information generated through the base station controller 2820.

Methods disclosed in the claims and/or methods according to the embodiments described in the specification of the disclosure may be implemented by hardware, software, or a combination of hardware and software. When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the disclosure, the term “unit” or “module” may refer to a hardware component such as a processor or circuit, and/or a software component executed by a hardware component such as a processor.

The “unit” or “module” may be stored in an addressable storage medium and may be implemented by a program executable by a processor. For example, the “unit” or “module” may be implemented by elements such as software elements, object-oriented software elements, class elements, and task elements, processes, functions, attributes, procedures, sub-routines, segments of program codes, drivers, firmware, micro-codes, circuits, data, databases, data structures, tables, arrays, and parameters.

Particular implementations described herein are merely an embodiment, and do not limit the scope of the disclosure in any way. For the brevity and conciseness of the specification, a description of conventional electronic components, control systems, software, and other functional aspects of these systems may be omitted.

Also, as used herein, the expression “including at least one of a, b, or c” may mean “including only a”, “including only b”, “including only c”, “including a and b”, “including b and c”, “including a and c”, or “including a, b, and c all”.

Although specific embodiments have been described in the detailed description of the disclosure, it will be apparent that various modifications and changes may be made thereto without departing from the scope of the disclosure. For example, it will be apparent that all or a part of a particular embodiment may be combined with all or a part of one or more other embodiments, which also falls within the scope of the disclosure. Therefore, the scope of the disclosure should not be defined as being limited to the embodiments set forth herein, but should be defined by the appended claims and equivalents thereof.

1. A method performed by a first terminal of a wireless communication system, the method comprising:
receiving configuration information related to measurement regarding a cross-link interference (CLI)-reference signal (RS) from a base station;
receiving a CLI-RS from a second terminal, based on the configuration information; and
transmitting a CLI measurement result regarding the received CLI-RS to the base station,
wherein, in one or more downlink symbols corresponding to a time interval in which the CLI-RS is received from the second terminal, no downlink signal is received from the base station, based on the configuration information.

2. The method of claim 1, wherein, in case that the one or more downlink symbols comprise two consecutive downlink symbols, downlink muting is applied to the two consecutive downlink symbols, and the time interval comprises one uplink symbol.

3. The method of claim 1, wherein, in case that the one or more downlink symbols comprise one downlink symbol, downlink muting is applied to the one downlink symbol, and the time interval comprises two consecutive uplink symbols, and
wherein the two consecutive uplink symbols have a sync-free structure in which a cyclic shift is applied between cyclic prefixes (CPs).

4. The method of claim 1, wherein the CLI measurement result comprises a result regarding CLI measurement between UEs in an identical cell.

5. A method performed by a first base station in a wireless communication system, the method comprising:
transmitting configuration information related to measurement regarding a (cross-link interference (CLI)-reference signal (RS) to a second base station;
transmitting uplink scheduling information based on the configuration information to a terminal;
receiving a CLI-RS from the second base station, based on the configuration information; and
performing CLI measurement regarding the received CLI-RS,
wherein in one or more uplink symbols corresponding to a time interval in which the CLI-RS is received from the second base station, no uplink signal is received from the terminal, based on the configuration information.

6. The method of claim 5, wherein, in case that the one or more uplink symbols comprise two consecutive uplink symbols, uplink muting is applied to the two consecutive uplink symbols, and the time interval comprises one downlink symbol.

7. The method of claim 5, wherein, in case that the one or more uplink symbols comprise one uplink symbol, uplink muting is applied to the one uplink symbol, and the time interval comprises two consecutive downlink symbols,
wherein the two consecutive downlink symbols have a sync-free structure in which a cyclic shift is applied between cyclic prefixes (CP), and
wherein the CLI measurement include CLI measurement between base stations of different cells.

8. A first terminal of a wireless communication system, the first terminal comprising:
a transciver; and
a controller connected to the transceiver,
wherein the controller is configured to:
receive configuration information related to measurement regarding a cross-link interference (CLI)-reference signal (RS) from a base station;
receive a CLI-RS from a second terminal, based on the configuration information; and
transmit a CLI measurement result regarding the received CLI-RS to the base station, and
wherein, in one or more downlink symbols corresponding to a time interval in which the CLI-RS is received from the second terminal, no downlink signal is received from the base station, based on the configuration information.

9. The first terminal of claim 8, wherein, in case that the one or more downlink symbols comprise two consecutive downlink symbols, downlink muting is applied to the two consecutive downlink symbols, and the time interval comprises one uplink symbol.

10. The first terminal of claim 8, wherein in case that the one or more downlink symbols comprise one downlink symbol, downlink muting is applied to the one downlink symbol, and the time interval comprises two consecutive uplink symbols, and
wherein the two consecutive uplink symbols have a sync-free structure in which a cyclic shift is applied between cyclic prefixes (CPs).

11. The first terminal of claim 8, wherein the CLI measurement result comprises a result regarding CLI measurement between UEs in an identical cell.

12. A first base station in a wireless communication system, the first base station comprising:
a transceiver; and
a controller connected to the transceiver,
wherein the controller is configured to:
transmit configuration information related to measurement regarding a (cross-link interference (CLI)-reference signal (RS) to a second base station;
transmit uplink scheduling information based on the configuration information to a terminal;
receive a CLI-RS from the second base station, based on the configuration information; and
perform CLI measurement regarding the received CLI-RS, and
wherein in one or more uplink symbols corresponding to a time interval in which the CLI-RS is received from the second base station, no uplink signal is received from the terminal, based on the configuration information.

13. The first base station of claim 12, wherein, in case that the one or more uplink symbols comprise two consecutive uplink symbols, uplink muting is applied to the two consecutive uplink symbols, and the time interval comprises one downlink symbol.

14. The first base station of claim 12, wherein, in case that the one or more uplink symbols comprise one uplink symbol, uplink muting is applied to the one uplink symbol, and the time interval comprises two consecutive downlink symbols, and
wherein the two consecutive downlink symbols have a sync-free structure in which a cyclic shift is applied between cyclic prefixes (CP).

15. The first base station of claim 12, wherein the CLI measurement include CLI measurement between base stations of different cells.
